(19) United States
(12) Patent Application Publication
(10) Pub. No.: US 2007/0178844 A1
(43) Pub. Date: Aug. 2, 2007

(54) Method and system for identifying signal frequencies emitted at a known location using geographically distributed RF sensors

(76) Inventor: Mutsuya Ii, Shoreline, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/345,181

(22) Filed: Jan. 31, 2006

(51) Int. Cl. H04B 17/00

(52) U.S. Cl. 455/67.11

(57) ABSTRACT

A network of three or more RF sensors acquires RF data in terms of power versus frequency data or energy versus frequency data. An expected power or energy difference between RF sensors in each pair of RF sensors is calculated based on the known location. The observed power or energy differences are then compared with the expected differences to determine whether the expected and observed differences match or nearly match for one or more particular frequencies. When the observed and expected differences match or nearly match, the particular frequency is determined to be a probable frequency for the RF signal emitted at the known location.

### BACKGROUND

RF signals are used in a variety of applications, such as medical imaging, broadcast radio, and wireless communications. It is often desirable to determine if an RF signal is present, and if so, the location of the signal emitter. For example, the transmission of an RF signal may be detected as part of a criminal investigation, or to detect and locate unauthorized or unintentional transmissions.

FIG. 1 is a conceptual diagram of a system for geolocating an RF signal emitter in accordance with the prior art. An RF signal is received by RF sensor system 100. To determine the location of the emitter transmitting the RF signal, three or more RF sensors in system 100 receive the RF signal. The location of the emitter is determined using one of several known techniques, such as time-difference-of-arrival.

### SUMMARY

In accordance with the invention, a method and system for identifying signal frequencies emitted at a known location using geographically distributed RF sensors are provided. A network of three or more RF sensors acquires RF data in terms of power versus frequency data or energy versus frequency data. An expected power or energy difference between RF sensors in each pair of RF sensors is calculated based on the known location. The observed power or energy differences are then compared with the expected differences to determine whether the expected and observed differences match or nearly match for one or more particular frequencies. When the observed and expected differences match or nearly match, the particular frequency is determined to be a probable frequency for the RF signal emitted at the known location.

### BRIEF DESCRIPTION OF THE DRAWINGS

FIG. 1 is a conceptual diagram of a system for geolocating an RF signal emitter in accordance with the prior art;

FIG. 2 is a conceptual diagram of a system for identifying one or more signal frequencies in an embodiment in accordance with the invention;

FIG. 3 is a block diagram of system 200 in FIG. 2 in an embodiment in accordance with the invention;

FIG. 4 is a flowchart of a method for identifying one or more signal frequencies emitted at a known location in an embodiment in accordance with the invention;

FIGS. 5A-5B depict a flowchart of a method for identifying and monitoring one or more signal frequencies emitted at a known location in an embodiment in accordance with the invention;

FIG. 6A is an illustration of a first table that may be used in block 410 of FIG. 4 and block 514 of FIG. 5B;

FIG. 6B is an illustration of a second table that may be used in block 410 of FIG. 4 and block 514 of FIG. 5B; and

FIG. 7 is a pictorial representation of two traces of the power of an RF signal over a frequency spectrum that may be used in block 410 of FIG. 4 and in block 514 of FIG. 5B.

### DETAILED DESCRIPTION

The following description is presented to enable embodiments in accordance with the invention to be made and used, and is provided in the context of a patent application and its requirements. Various modifications to the disclosed embodiments will be readily apparent, and the generic principles herein may be applied to other embodiments. Thus, the invention is not intended to be limited to the embodiments shown, but is to be accorded the widest scope consistent with the appended claims and with the principles and features described herein.

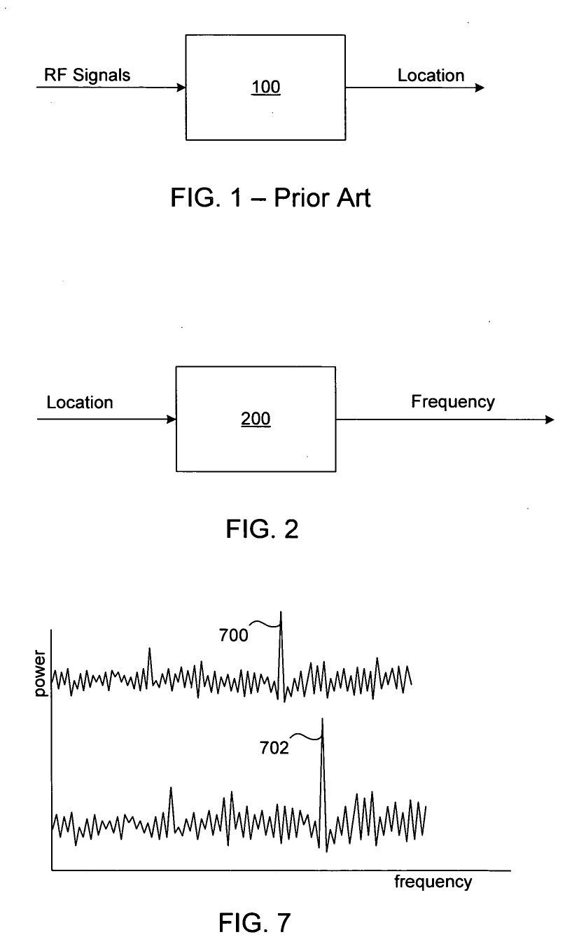

With reference to the figures and in particular with reference to FIG. 2, there is shown a conceptual diagram of a system for identifying one or more signal frequencies in an embodiment in accordance with the invention. System 200 determines one or more probable frequencies for an RF signal emitted at a given location. Unlike the system of FIG. 1, which determines a location using received RF signals, the system shown in FIG. 2 determines probable signal frequencies for RF signals using expected energy or power ratios determined for the known location.

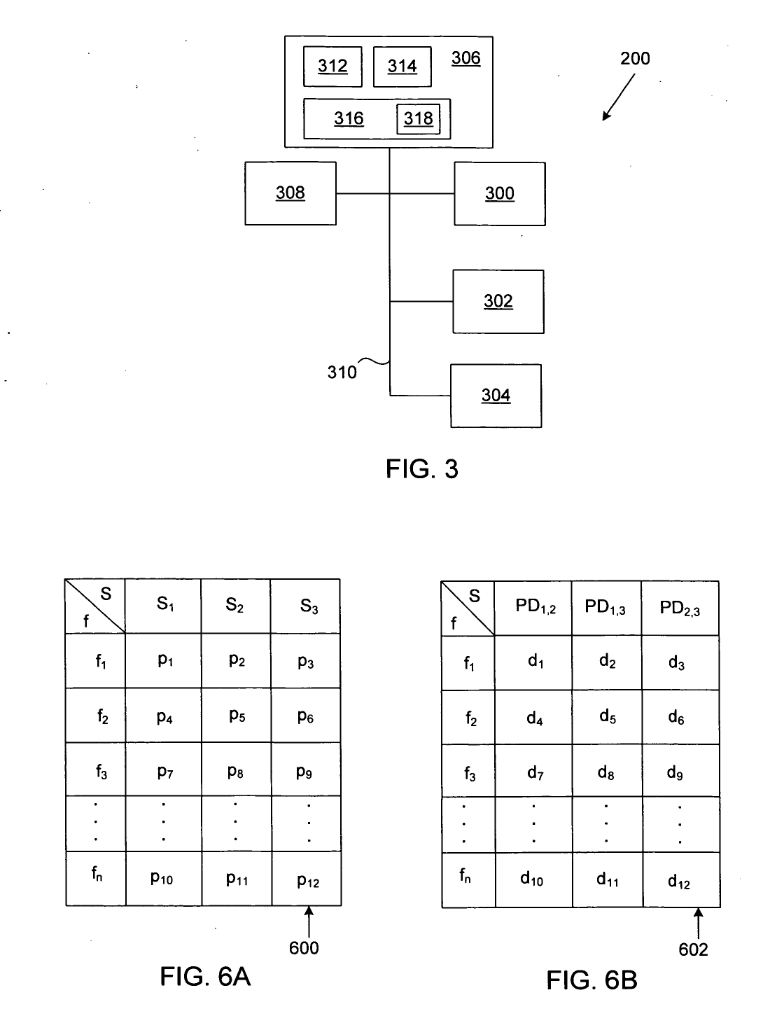

FIG. 3 is a block diagram of system 200 in FIG. 2 in an embodiment in accordance with the invention. System 200 is a network of RF sensors arranged in any given topology in embodiments in accordance with the invention. System 200 includes RF sensors 300, 302, 304, central processing device 306, and common network clock 308 each connected through network connection 310. Network connection 310 is implemented as a wired connection in an embodiment in accordance with the invention. For example, network 200 is a wired local area network (LAN) in an embodiment in accordance with the invention. In other embodiments in accordance with the invention, network connection 310 is implemented as a wireless connection, such as a wireless local area network (WLAN), or as a combination of both wired and wireless connections.

Central processing device 306 includes output device 312, processor 314, memory 316, and database 318. Central processing device 306 is implemented as a discrete processing device, such as a computer, in an embodiment in accordance with the invention. In another embodiment in accordance with the invention, central processing device 306 is integrated within an RF sensor in network 200.

RF sensors 300, 302, 304 are implemented as any device that captures RF data in terms of power versus frequency or amplitude versus frequency. One example of such an RF sensor is a spectrum analyzer. RF sensors 300, 302, 304 transmit the data to central processing device 306 in an embodiment in accordance with the invention. Processor 314 determines one or more probable signal frequencies using the received data. Output device 312 then outputs the probable frequency or frequencies to a user. Output device 312 is implemented, for example, as a display or printing device. In other embodiments in accordance with the invention, the probable frequency or frequencies are stored in memory 316. And in yet another embodiment in accordance with the invention, database 318 stores spectral traces received from multiple RF sensors. The spectral traces are then used to determine the probable frequency or frequencies emitted at one or more locations.

Central processing device 306 and RF sensors 300, 302, 304 also exchange timing information that is used to synchronize RF sensors 300, 302, 304 to a common time defined by common network clock 308. Common network clock 308 is integrated within central processing device 306 or within an RF sensor in network 200 in an embodiment in accordance with the invention. RF sensors 300, 302, 304 acquire RF data over the same period of time when the sensors are synchronized to a common network time.

Network 200 uses the Institute of Electrical and Electronic Engineers (IEEE) 1588 Standard to synchronize RF sensors 300, 302, 304 to a common network time in an embodiment in accordance with the invention. Other embodiments in accordance with the invention may implement different time synchronizing protocols. Moreover, the network devices that add delay, such as, for example, a switch, router, and repeater, may need symmetrical transmission and reception delays in other embodiments in accordance with the invention. In some of these embodiments, the delays may be compensated for in the RF system calibrations when the mean of the asymmetrical delays is stationary over a time interval.

The required accuracy in synchronizing RF sensors 300, 302, 304 depends on the application. More precise timing accuracy is required in some applications, such as in geolocation applications. For signal detection, the timing accuracy is determined by the amount of memory in each device and the network latency. In other embodiments in accordance with the invention, other types of devices or systems may be used for the common network clock, including, but not limited to, other networking timing protocols, such as NTP, global positioning systems (GPS), high stability internal clocks such as atomic clocks, or any other clock with long-term stability compatible with the application.

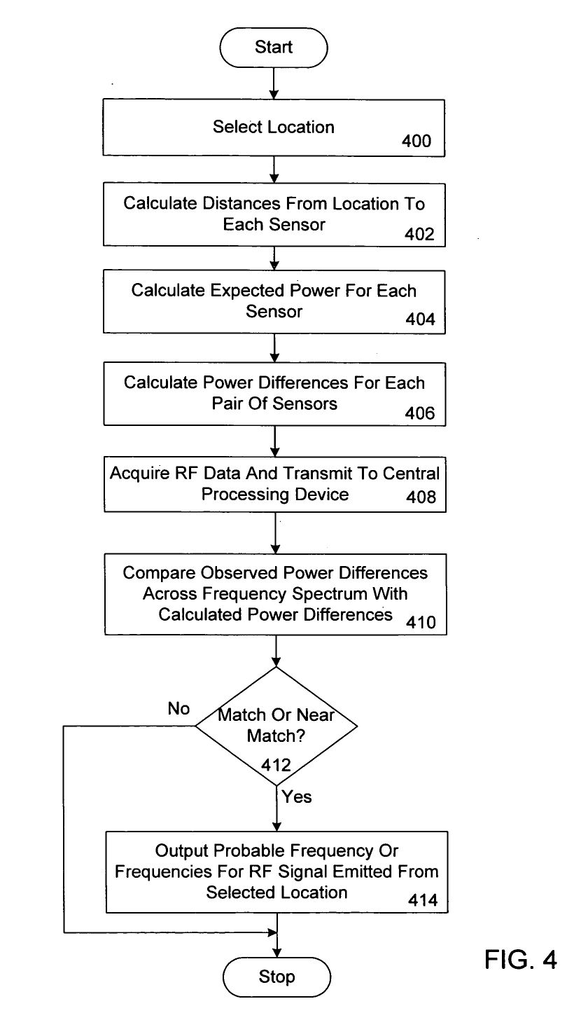

Referring to FIG. 4, there is shown a flowchart of a method for identifying one or more signal frequencies emitted at a known location in an embodiment in accordance with the invention. The method of FIG. 4 is performed in real-time in an embodiment in accordance with the invention. Initially a location to examine is selected, as shown in block 400. Because the locations of the RF sensors are known, the distances between the RF sensors and the selected location can be determined. Thus, the distance between each RF sensor and the selected location is determined at block 402.

The expected power for each RF sensor is then determined, as shown in block 404. The expected power for a sensor is determined by the equation 1/(d)², where d is the distance between the selected location and the RF sensor. Once the expected power has been calculated for each RF sensor, the expected power difference for each pair of sensors is calculated (block 406). The power difference is determined by comparing 1/(d1)² with 1/(d2)² for sensor 1 and sensor 2 in each sensor pair in an embodiment in accordance with the invention. By way of example only, if sensor 1 is ¼ the distance to the selected location and sensor 2 is ¾ the distance, the energy at sensor 1 for a non-directional RF signal is expected to be 9 times greater than the energy observed at sensor 2. In terms of power, a difference of 19.08 dB ((20 log(9))) is expected between sensor 1 and sensor 2.

RF data is then acquired by the RF sensors and a spectrum trace of power versus frequency generated at block 408. Next, at block 410, the observed power differences for the pairs of sensors are compared with the expected power differences. A determination is then made at block 412 as to whether the observed power differences match or nearly match the expected power differences at one or more particular frequencies. If so, each particular frequency is determined to be a probable frequency for the RF signal emitted at the known location. The frequency is a probable frequency when the observed power differences match the expected power differences, nearly match the expected power differences within a given error range, or if there is more than one near match in an embodiment in accordance with the invention.

The probable frequency or frequencies are then output, as shown in block 414. The one or more probable frequencies are displayed to a user in an embodiment in accordance with the invention. In another embodiment in accordance with the invention, a printed document listing the probable frequency or frequencies is generated. And in yet another embodiment, the probable frequency or frequencies are transmitted to the RF sensors in a network.

The method shown in FIG. 4 may be used for a variety of purposes. By way of example only, law enforcement officials may determine a person of interest resides at a particular address and want to ascertain if any RF signals are emitted from that address. The method of FIG. 4 is then used to determine the probable frequency or frequencies emitted at that address. This allows the law enforcement officials to then monitor the probable frequency or frequencies emitted at that location. Monitoring of the frequencies is performed by a network of RF sensors (FIG. 3) in an embodiment in accordance with the invention.

Although FIG. 4 describes a method for identifying one or more probable frequencies using power differences, embodiments in accordance with the invention are not limited to this implementation. Other embodiments in accordance with the invention identify one or more probable frequencies emitted at a known location using differences in other signal values, such as, for example, differences in energy levels.

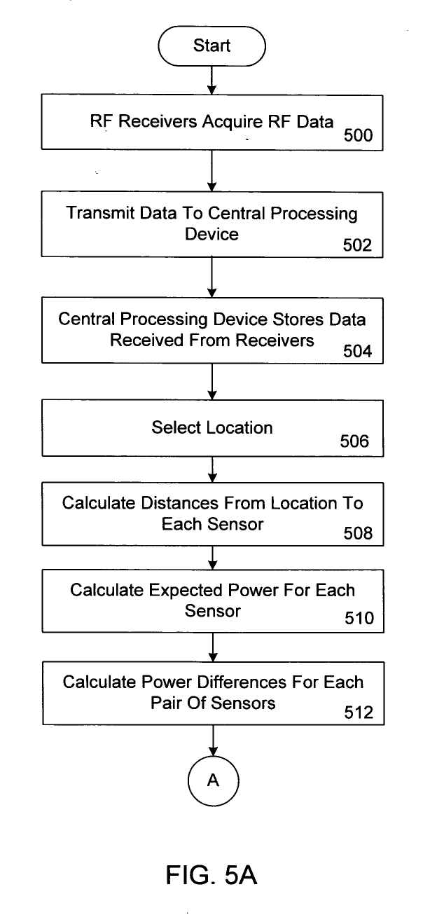

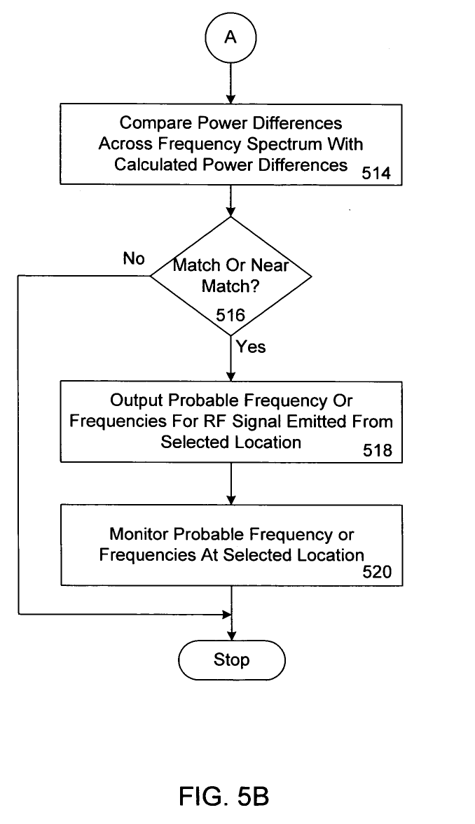

FIGS. 5A-5B depict a flowchart of a method for identifying and monitoring one or more signal frequencies emitted at a known location in an embodiment in accordance with the invention. The method shown in FIGS. 5A-5B is performed after spectral traces are generated by multiple RF sensors and stored in a central processing device in an embodiment in accordance with the invention. Initially multiple RF sensors each acquire RF data and generate a spectrum trace of power versus frequency, as shown in block 500. The RF sensors then transmit the spectral traces to a central processing device (block 502) and the central processing device stores the traces (block 504). The central processing device stores the traces in a database or table in an embodiment in accordance with the invention. The spectral data received from the sensors is time-aligned spectral data because the RF sensors are all synchronized to the common network clock in an embodiment in accordance with the invention.

A location is then selected at block 506. The location is selected some time after the traces are stored in the central processing device in an embodiment in accordance with the invention. The distance between each RF sensor and the selected location is then determined at block 508. The expected power for each RF sensor is also determined, as shown in block 510. Once the expected power has been calculated for each RF sensor, the expected power difference for each pair of sensors is calculated (block 512).

Next, at block 514, the observed power differences for the pairs of sensors are compared with the expected power differences. A determination is then made at block 516 as to whether the observed power differences match or nearly match the expected power differences at one or more particular frequencies. If so, each particular frequency is determined to be a probable frequency for the RF signal emitted at the known location. The frequency is a probable frequency when the observed power differences match the expected power differences, nearly match the expected power differences within a given error range, or if there is more than one near match in an embodiment in accordance with the invention.

The probable frequency or frequencies are then output (block 518) and monitored at the selected location (block 520). The one or more probable frequencies are displayed to a user in an embodiment in accordance with the invention. In another embodiment in accordance with the invention, a printed document listing the probable frequency or frequencies is generated. And in yet another embodiment, the probable frequency or frequencies are transmitted to the RF sensors using the network.

The method shown in FIGS. 5A-5B may be used for a variety of purposes. By way of example only, law enforcement officials may determine a person of interest resides at a particular address previously examined by a network of RF sensors. The method of FIGS. 5A-5B is used to determine which frequencies were previously emitted at that address. This allows the law enforcement officials to then presently monitor the probable frequency or frequencies emitted at that location. Monitoring of the frequencies is performed by a network of RF sensors (FIG. 3) in an embodiment in accordance with the invention.

Although FIGS. 5A-5B describe a method for identifying one or more probable frequencies using power differences, embodiments in accordance with the invention are not limited to this implementation. Other embodiments in accordance with the invention identify one or more probable frequencies emitted at a known location using differences in other signal values, such as, for example, differences in energy levels.

The power differences can be compared at block 410 in FIG. 4 and at block 514 in FIG. 5B using one of several techniques. FIG. 6A is an illustration of a first table that may be used in block 410 of FIG. 4 and in block 514 of FIG. 5B. Table 600 records the observed power levels (p₁, p₂, p₃ . . . p₁₂) at various frequencies (f₁, f₂, f₃ . . . fₙ) for each sensor (S₁, S₂, S₃). The observed power levels are used to determine the power differences for pairs of sensors, which are then compared with the expected power differences to determine whether the observed power differences match or nearly match the expected power differences at a particular frequency or frequencies. In other embodiments in accordance with the invention, table 600 records observed energy levels at various frequencies (f₁, f₂, f₃ . . . fₙ) for each sensor (S₁, S₂, S₃).

FIG. 6B is an illustration of a second table that may be used in block 410 of FIG. 4 and in block 514 of FIG. 5B. Table 602 records the differences in power levels (d₁, d₂, d₃ . . . d₁₂) at various frequencies ((f₁, f₂, f₃ . . . fₙ) for each sensor pair (SP_{1,2}, SP_{1,3,} SP_{2,3}). The observed power differences are then compared with the expected power differences to determine whether the observed power differences match or nearly match the expected power differences at a particular frequency or frequencies. In other embodiments in accordance with the invention, table 602 records observed differences in energy levels at various frequencies (f₁, f₂, f₃ . . . fₙ) for each sensor (S₁, S₂, S₃).

And finally, FIG. 7 is a pictorial representation of two traces of the power of an RF signal over a frequency spectrum that may be used in block 410 of FIG. 4 and in block 514 of FIG. 5B. A trace 700, 702 is generated for the RF data captured by each sensor in an embodiment in accordance with the invention. Traces 700, 702 are then overlaid with each other in order to compare power differences at various frequencies and determine whether the observed power differences match or nearly match the expected power differences for a particular frequency or frequencies. In FIG. 6, traces 700, 702 are shown separately for the sake of clarity. In other embodiments in accordance with the invention, traces of signal amplitudes versus frequency are generated and used to determine whether the observed energy differences match or nearly match the expected energy differences for a particular frequency or frequencies.

Although the descriptions of FIGS. 3-7 include the use of three RF sensors, embodiments in accordance with the invention are not limited to three sensors. Three or more RF sensors may be used to identify one or more probable frequencies emitted at a known location. Typically the confidence level associated with the probable frequency or frequencies increases with the number of sensors while the error associated with the probable frequency or frequencies decreases.

1. A method for identifying one or more probable signal frequencies for an RF signal emitted at a known location using geographically distributed RF sensors, comprising:
calculating an expected signal value difference between RF sensors in each pair of RF sensors based on the known location;
acquiring RF data over a given frequency spectrum; and
comparing observed signal value differences with the expected signal value differences over the given frequency spectrum.

2. The method of claim 1, further comprising:
determining whether one observed signal value difference substantially matches one expected signal value difference for one pair of sensors; and
repeatedly determining whether one observed signal value difference substantially matches one expected signal value difference for the remaining pairs of sensors.

3. The method of claim 2, further comprising determining the one or more probable signal frequencies of the RF signal when the observed signal value differences substantially match the expected signal value differences.

4. The method of claim 1, further comprising:
each RF sensor generating a spectral trace of the acquired RF data;
transmitting the spectral traces over a network connection; and
storing the spectral traces in a central processing device connected to the RF sensors.

5. The method of claim 1, wherein the signal value differences comprise power differences.

6. The method of claim 1, wherein the signal value differences comprise energy differences.

7. The method of claim 1, wherein comparing observed signal value differences with the expected signal value differences comprises comparing power versus frequency graphs associated with the RF sensors.

8. The method of claim 1, wherein comparing observed signal value differences with the expected signal value differences comprises comparing amplitude versus frequency graphs associated with the RF sensors.

9. The method of claim 1, wherein comparing observed signal value differences with the expected signal value differences comprises generating a table comprised of energy differences.

10. The method of claim 1, wherein comparing observed signal value differences with the expected signal value differences comprises generating a table comprised of power differences.

11. The method of claim 1, wherein comparing observed signal value differences with the expected signal value differences comprises generating a table comprised of energy levels.

12. The method of claim 1, wherein comparing observed signal value differences with the expected signal value differences comprises generating a table comprised of power levels.

13. The method of claim 1, further comprising outputting the one or more probable signal frequencies.

14. The method of claim 1, further comprising storing the one or more probable signal frequencies.

15. A system for identifying one or more probable signal frequencies for an RF signal emitted at a known location, comprising:
a central processing device; and
a plurality of RF sensors each connected to the central processing device through a network connection, wherein each RF sensor is operable to acquire signal value versus frequency data for acquired RF data and transmit the signal value versus frequency data to the central processing device using the network connection, wherein the central processing device determines the one or more probable signal frequencies using the received signal value versus frequency data.

16. The system of claim 15, wherein the signal value versus frequency data comprises power versus frequency data.

17. The system of claim 15, wherein the signal value versus frequency data comprises amplitude versus frequency data.

18. The system of claim 15, wherein the central processing device comprises a discrete computing device.

19. The system of claim 15, wherein the central processing device is integrated within one RF sensor in the plurality of RF sensor.

20. The system of claim 15, wherein the central processing device comprises an output device and a memory.
